(19) United States
(12) Patent Application Publication
(10) Pub. No.: US 2008/0233373 A1
(43) Pub. Date: Sep. 25, 2008

(54) METHOD OF REDUCING FILM DENSITY AND RELATED PRODUCT

(76) Inventor: Theodore Coburn, Coventry, RI (US)

Correspondence Address: CHRIS A. CASEIRO, VERRILL DANA, LLP, ONE PORTLAND SQUARE, PORTLAND, ME, 04112-0586, US

(21) Appl. No.: 12/053,303

(22) Filed: Mar. 21, 2008

Related U.S. Application Data
(60) Provisional application No. 60/896,409, filed on Mar. 22, 2007.

(51) Int. Cl. B32B 3/26; B32B 7/02

(52) U.S. Cl. 428/215; 428/315.5

(57) ABSTRACT

A microvoided film formed by mixing a microvoid forming additive with a composition including a polymeric material. The microvoided film includes a printability additive. The microvoids formed during the processing of the composition to convert it into a film result in a reduction of the density of the film, making a lighter weight film requiring less polymeric material to produce a film of desired thickness while maintaining suitable structural characteristics. The microvoids are formed through β crystallization of the polymeric material during a cold drawing stage of the film fabrication process. The microvoided film may be fabricated to be opaque with or without pigment additive included in the composition.

### CROSS REFERENCE TO RELATED APPLICATION

The present application claims the priority benefit of U.S. provisional patent application Ser. No. 60/896,409, filed Mar. 22, 2007, entitled “A METHOD OF REDUCING FILM DENSITY AND RELATED PRODUCT” of the same named inventor. The entire contents of that prior application are incorporated herein by reference.

### BACKGROUND OF THE INVENTION

1. Field of the Invention

The present invention relates to films or sheets used for a wide variety of purposes. Such films or sheets are hereinafter referred to as “film” or “films.” More particularly, the present invention relates to films fabricated of polymeric materials processed to reduce original material density while maintaining desirable characteristics such as printability, for example. The present invention is directed to a single layer film exhibiting substantial reduction in density in comparison to predecessors without substantially diminishing other desired characteristics. The film of the present invention may also form part of a multilayer extrusion.

2. Description of the Prior Art

Polymer-based films may be used for a wide array of purposes, from coatings to labels to tags and so forth. Polymer-based films have found many applications because they have a desired range of properties including relatively high strength in relation to thickness, suitability for different manufacturing processes, flexibility, and printability. The particular characteristics of interest may be established by the composition of the material used to make the film and its processing. Specifically, the film has a polymeric material base, which is ordinarily a thermoplastic, such as polyethylene, polypropylene, homopolymers and/or co-polymers thereof and/or any combination thereof, and one or more additives designed to adjust, modify or enhance the characteristics of the base material. For example, additives may be employed to change the color of the base polymer, increase its flexibility, make it printable, and/or other features of interest. In addition, certain characteristics may be imparted to the film during the processing. For example, the composition may be stretched in a certain manner and/or different directions to impart different structural characteristics. It may also be subjected to selectable heating and cooling regimens to impart desired structural and non-structural characteristics. Further, it may be surface modified to enhance or diminish printability, glossiness, bondability and the like.

Polymeric film products are ordinarily sold commercially by their original manufacturers by weight rather than by volume or coverage area. Their customers wish to pay as little as possible to obtain films having satisfactory characteristics with a thickness that is as minimal as possible but with the largest coverage area possible. A goal of the film manufacturers then is to maintain, improve and expand film characteristics while keeping the weight, and therefore the price, of the film as low as possible. These goals are generally opposed to one another, particularly when additives are required to produce certain film characteristics and those additives are heavier than the base material of the film.

As an example of these competing goals, an end user may wish to have a film that is relatively thin, perhaps on the order of 10 mils or less and that is white. In order to make a white polymer-based film, the film manufacturer must do something to the base material. The standard practice is to add an additive, such as a whitening additive including, but not limited to, titanium dioxide or calcium carbonate, to the base material prior to processing. Such additives ensure suitable film coloring, but they are denser than the base material and therefore drive up the film's density and the cost per weight of the finished product. Other additives may cause similar problems. It is therefore a desirable goal to create a film having desired characteristics without substantially increasing its density and, ideally, to even reduce its density. In general, it is to be noted that the base polymer materials ordinarily used to make polymer-based films have a density value of about 0.9 g/cc. Additives often drive that density up to about 1.2 g/cc or more.

There are some commercially available polymeric films having sufficient structural and other characteristics for certain restricted applications and that are also of relatively low density, or at least they maintain the density of the base material. These types of films may be used as decorative ribbon or in the food packaging industry, for example. The process of density reduction results in reduced structural characteristics, undesirable surface features, or a combination of the two. In one process to reduce film density, the base mixture is foamed, either with a foam-inducing additive or by whipping air into the material while molten. This foaming reduces film density but also reduces its strength and often imparts an undesirable mottling to the surface—a feature that makes printing on the film difficult. In another process, an additive with varied surface features is added to the composition in a cavitation during film orientation such that the additive creates pockets in the finished film. This process is better for maintaining structural integrity, but it too imparts less than an ideal surface characteristic.

Therefore, what is needed is a polymeric film or films having a suitable range of desired structural and non-structural characteristics at a density lower than has heretofore been possible with existing polymeric films. What is also needed is a related method for fabricating such an improved polymeric film.

### SUMMARY OF THE INVENTION

It is an object of the present invention to provide a polymeric film or films having a suitable range of desired structural and non-structural characteristics at a density lower than has heretofore been possible with existing polymeric films. It is also an object of the present invention to provide a method for fabricating such an improved polymeric film.

These and other objectives are achieved in the present invention, which is a microvoided film comprising a structural material and a microvoid forming additive. The composition may also include one or more other additives including, but not limited to, materials suitable for making the film of a specific color, printable, glossy and/or to have certain desirable structural attributes. The structural material is preferably a polyolefin, such as polyethylene, polypropylene, homopolymers and/or co-polymers thereof, and/or a combination thereof. The structural material may be formulated and processed to exhibit relatively high tensile strength with minimal shrinkage. The microvoid forming additive is one that provides for substantially uniform disbursement throughout the structural material. The microvoid forming additive may be a β-nucleating agent. As an example, a product identified as BNX BETAPP-LN Beta Nucleated Polypropylene available from Mayzo, Incorporated of Norcross, Ga., has been found to be suitable as such an additive. Specifically, processing of a composition including this additive in accordance with the steps described herein appears to cause an increase in β crystallization of the polypropylene. This, in turn, results in the creation of microvoids in the composition including the structural layer. The creation of microvoids in the resultant film is of lower or reduced density in comparison to the density of the film without such microvoid creation, while maintaining sufficient structural characteristics.

The process of the present invention used to take advantage of the noted characteristics of the microvoid forming additive includes the step of “cold drawing” the film during the stretching process to ensure that the β crystallization transition occurs. This cold drawing generates microvoiding in the structural material and the formation of the microvoids causes the film to turn white. As a result, it is possible to reduce the amount of color pigment additive, such as titanium oxide or calcium carbonate, which would otherwise be required to make the end product film suitably white. In some applications, the whitening generated is sufficient to eliminate the pigment additive altogether. The ability to reduce the amount of such additives, which are ordinarily more dense than the structural material, aids in reducing the film product's final density.

The combination of use of the noted microvoid forming additive and the processing steps described herein result in a microvoided or reduced density film product of substantially reduced density without a substantial loss of structural properties. Further, the combination reduces or eliminates the need to add coloring pigment. These two advantages yield a product that is less expensive to make and therefore less expensive to consumers. Since there is minimal loss of structural properties, including tensile strength and transverse strength, and even some improvement in stiffness, the new film may be employed for any application that prior heavier films were used including, but not limited to, printable labels, tapes, coaxial cable films, tags and the like. Moreover, it has been observed in samples of the film that the surface has little to no pock marking, which is a substantial advantage over the prior foamed and cavitated film products. These features are available in the film of the present invention with little adjustment required to existing product processing equipment and steps. These advantages of the film with microvoid forming additive were surprising and unexpected based on prior experiences with void creating techniques. Moreover, the ability to use the composition in a wide range of applications as a monolayer film was also surprising and unexpected. Further, it was unexpected to discover that combining the microvoid forming additive and a printability additive with the base component of the structural material would produce a single layer that maintained structural integrity, desired opacity, reduced density and effective printability. Initial contemplation of such a combination resulted in a concern that at least one component would have an adverse impact on a desired characteristic produced by another component. Samples films described herein including that combination of microvoid forming additive and printability additive with the structural material exhibited a contrary finding. Moreover, the combination was synergistic in that desired printability was achieved using lesser amounts of printability additive than was originally thought to be required.

The details of one or more examples related to the invention are set forth in the accompanying drawing and the description below. Other features, objects, and advantages of the invention will be apparent from the description and accompanying drawing.

### BRIEF DESCRIPTION OF THE DRAWINGS

FIG. 1 is a simplified diagrammatic view of a film processing system of the present invention to fabricate the microvoided film of the present invention.

FIG. 2 is a first table showing selected characteristics of an existing monolayer polymeric film identified as PR White with a whitening pigment but without a microvoid forming additive for consideration in comparison to examples of the microvoided film of the present invention.

FIG. 3 is a second table showing selected characteristics of a first example of the microvoided film of the present invention identified as S-554 for consideration in comparison to the PR White film of FIG. 2.

FIG. 4 is a third table showing selected characteristics of a second example of the microvoided film of the present invention identified as S-555 for consideration in comparison to the PR White film of FIG. 2.

FIG. 5 is a fourth table showing selected characteristics of a third example of the microvoided film of the present invention identified as S-556 for consideration in comparison to the PR White film of FIG. 2.

### DETAILED DESCRIPTION OF THE PREFERRED EMBODIMENT

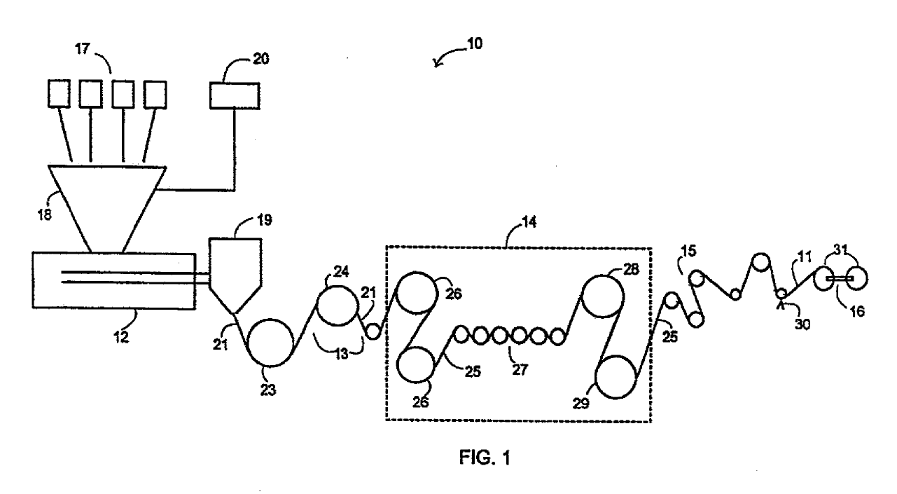

FIG. 1 shows a simplified diagrammatic view of a film fabrication system 10 used in the novel fabrication process of the present invention to create a novel microvoided (reduced density) film stock 11 having reduced density while maintaining structural integrity and the capability to be used in a wide range of applications. Primary components of the system 10 include an extruder 12, a roll unit 13, a film-orientation unit 14, a corona treatment unit 15, and an end-product winder 16. The extruder 12 is used to combine a primary structural material, preferably a polypropylene homopolymer or a polypropylene copolymer, with a microvoid forming additive, and optionally one or more other additives selected to establish in the final film product suitable characteristics of interest. The structural material may be any polymeric material that nucleates such as, for example, ethylene vinyl acetate and ethylene methacrylate. The microvoid forming additive may be a β-nucleating agent. As an example, a product identified as BNX BETAPP-LN Beta Nucleated Polypropylene available from Mayzo, Incorporated of Norcross, Ga., has been found to be a suitable microvoid forming additive. Secondary additives include, for example but not intending to be limited thereto, a pigment, such as a whitening pigment, and a printable material, preferably ethyl-vinyl-acetate (EVA) or ethyl-methacrylate (EMA) in a carrier, which carrier may be polyethylene. Suitable materials and components for the structural material and optional additives are further described in U.S. Pat. No. 6,136,439 entitled “Monolayer Polymeric Film And Method Of Fabrication” issued on Oct. 24, 2000, and U.S. Pat. No. 6,703,447 entitled “High Bi-directional Strength Monolayer Polymeric Film And Method Of Fabrication” issued Mar. 9, 2004. Both patents are in the name of the inventor of the present invention. The entire contents of both referenced patents are incorporated herein by reference. The combination of the microvoid forming additive and the printable material as additives result in a surprising end product film that is reduced in density with superior ink retention for solvent, water and the most difficult UV ink systems. Further, the inclusion of the microvoid forming additive enables the manufacturer to maintain sufficient printability while lowering the amount of the printability additive required to maintain that film printability. Printable material additives found to be compatible include EVA and EMA, with EMA being more preferable in some instances.

The materials may be in pellet or other suitable form, and may include one or more supplemental components delivered via chutes of a component feeder 17 into a mix hopper 18. All of the components are then transferred from the hopper 18 into the extruder 12 for mixing at a selected temperature prior to transfer to a die 19. The extruder 12 and the die 19 can be of any type known to those skilled in the art to be suitable for mixing and extruding components of the type described herein. It is to be understood that the particular means for mixing the structural material and the additives may be selected by the film manufacturer. The combination of the structural material and any additives, such as the microvoid forming additive, is fluid-like in the extruder 12 and as that combination emerges from the die 19, so that mixing occurs. It is noted that those skilled in the art will recognize that optional additives may be included in the mixture dependent upon the particular application. Such additives may be print-enhancers, anti-blocks, anti-stats, slip additives and the like. The die 19 directs the mixed output from the extruder 12 as a monolayer film that is extrusion 21.

The extrusion 21 is transferred from the die 19 to a first casting chiller roll 23 of the roll unit 13. The extrusion 21 may be in a range of thicknesses when first reaching the roll 23, dependent upon the ultimate function of the stock 11 to be produced. For example, the extrusion 21 may be approximately, but is not limited to, 5-100 mils thick as it moves to the first casting chiller roll 23. The extrusion 21 moves from the first chiller roll 23 to a second casting chiller roll 24. Rolls 23 and 24 may be of any suitable temperature, but preferably at a minimum of about 200° F. This chilling of the extrusion 21 acts to solidify it into a film-like material. β crystallization of the extrusion 21 occurs at this stage of the process. The temperature for processing at this stage is selected to provide the most effective opportunity for β crystallization. While it has been determined that a temperature of at least 200° F. is suitable for the desired β crystallization, the invention is not limited thereto. Instead, the temperature selected must be considered based on the effectiveness of β crystallization. From the second chiller roll 24, the extrusion 21 is delivered to the film-orientation unit 14.

In the orientation unit 14, the extrusion 21 is stretched and may be oriented into a film 25 that can range in thickness from about 1-30 mils, dependent upon the desired function of the stock 11. A pre-heater pair of rollers 26 at a temperature of about 200°-270° F. warms and softens the extrusion 21 after the chill casting stage of the process. A series of stretching rollers 27 at a temperature of about 200° F. act to considerably increase the length of the film 25. That step thins the film 25 and will also create a unidirectional molecular orientation that provides increased strength and stiffness in the film 25. The “cold drawing” of the film 25 at this stage causes the previously β crystallized extrusion 21 to turn white. It also improves strength and stiffness without losing required die cutability, such as in the manufacture of labels, for example. This cold drawing stage is preferably carried out such that the stretch ratio of the film 25 is about 3-6.5 to 1 so that the film orientation and uniformity are satisfactory. This may be achieved by multi-staging the draw process through one or more sets of the indicated rollers.

In the next stage of the process, orientation heat setting and then stress-relieving or relaxing of the film 25 occurs as it is transferred to a series of heat-stabilization rollers represented by roller 28, which may be one or more rollers, that is/are at a temperature in the range of about 270° F. to about 310° F. This imparts better stiffness and flatness in the end product in that the film 25 is unstressed as it moves across a cooling roller 29 that may be at ambient temperature. The heat-set rollers have individual drive controllers between two or more individual rollers so as to control the speed of the film passing therethrough. This maintains the flow of the product through the stress relieving stage of the process.

From the orientation unit 14, the film 25 moves to the optional corona-treatment unit 15 where the film surface may be enhanced, such as for improved printability. Final processing of the film 25 may include cutting of rough film edges by a slitter 30. Scraps of the film 25 from the slitting process may be returned for re-introduction into the process and subsequent use. The final stock 11 is then wound onto transfer rolls 31 of the winder unit 16 for delivery to users. However, if it is desired to impart cross-wise (bi-directional) strength orientation of the film 25, it may be farther stretched by applying the film 25 or stock 11 to a tenter frame and heating in an oven (not shown). Alternatively, a blown film system known by those skilled in the art of the field of the present invention may be used to provide enhanced bidirectional strength of the stock 11 as an alternative to the extrusion system shown.

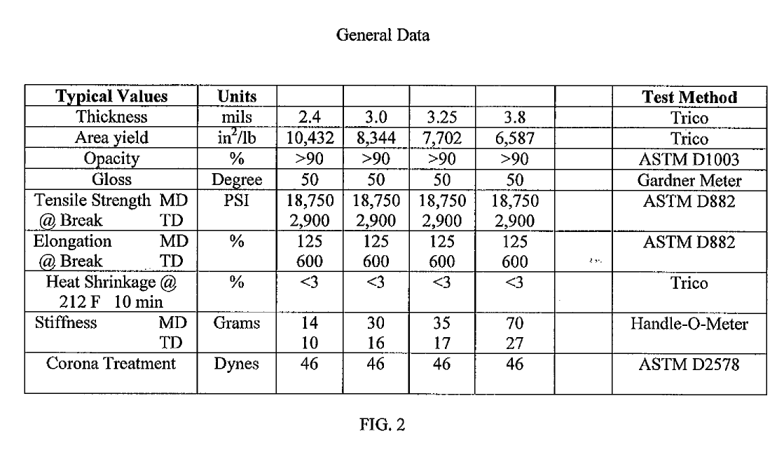

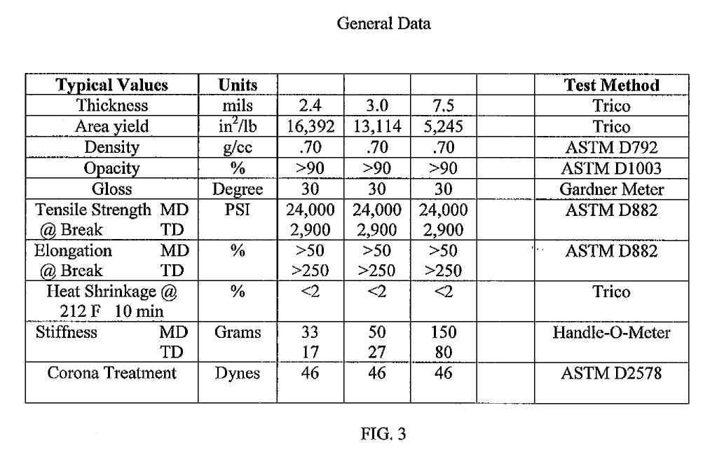

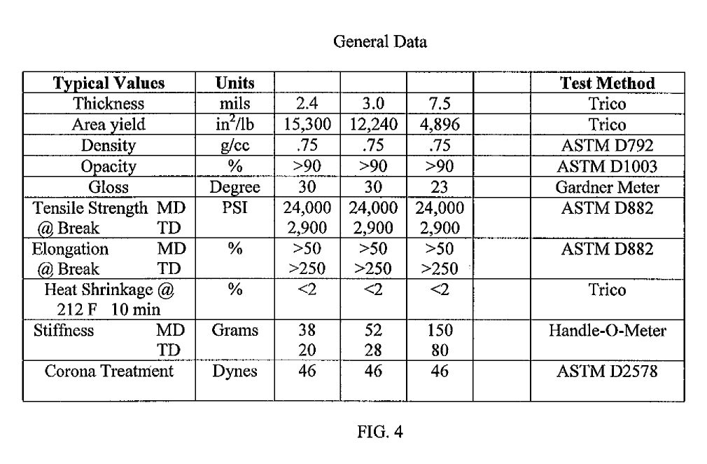

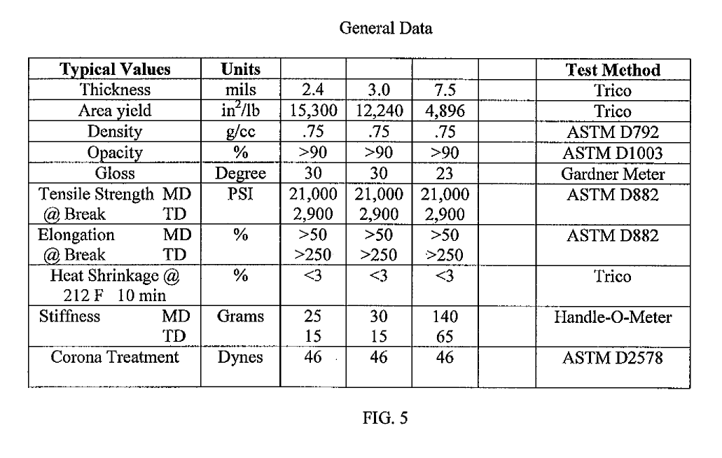

Tables of FIGS. 2-5 represent selected characteristics of four films including a prior monolayer film without microvoid forming additive identified as PR-White (FIG. 2), and three microvoided films of the present invention identified as S-554 (FIG. 3), S-555 (FIG. 4) and S-556 (FIG. 5). Each of the identified films includes the same base structural material, which is a polypropylene copolymer. The PR-White film has no microvoid forming additive but does have a whitening pigment and an additive to enhance film printability. That printability additive is EMA arranged to bloom to the surface of the film during processing such as described in referenced U.S. Pat. No. 6,703,447. The S-554 microvoided film represents a first sample of the microvoided film of the present invention. It includes the microvoid forming additive described herein. It does not include any whitening pigment nor does it include any additive to enhance film printability. The S-555 microvoided film represents a second sample of the microvoided film of the present invention. It includes the microvoid forming additive described herein and a relatively reduced amount of a whitening pigment. It does not include any additive to enhance film printability. The S-556 microvoided film represents a third sample of the microvoided film of the present invention. It includes the microvoid forming additive described herein and an additive to enhance film printability. That additive is EMA, but in a quantity that has been reduced by about 30%. In prior printable films including the same base structural material, it was determined that a greater amount of the printability additive, on the order of about 22% by weight, was required to produce a film of equivalent printability. The S-556 microvoided film also includes a whitening pigment. However, with the microvoid forming additive included, the amount of whitening pigment required to produce the S-556 film with desired opacity equivalent to the opacity of a film with similar structural characteristics but more dense was reduced by about 60%. The present invention is not limited to such specific additive quantities. Instead, the S-556 microvoided film is simply an example of the more general concept of the present invention, a microvoided film having printability characteristics, suitable structural characteristics, and reduced density.

It can be seen from the tables of FIGS. 2-5 that the structural, opacity and gloss characteristics of the three microvoided film examples of the present invention are substantially the same as that for the existing non-microvoided film. However, their densities are substantially less than that of the existing non-microvoided film of FIG. 2, which is about 1.12 g/cc. It is to be noted that the incorporation of the microvoid forming additive does generate some voiding at the surface of the film. Those surface voids enable more effective print material retention at the film surface such that the amount of print additive required may be reduced for those film products requiring printability characteristics. The S-556 microvoided film of FIG. 5 does have such an additive for optimal ink retention, and is particularly desirable in applications requiring certain film structural characteristics, such as those desired in a film applied to a flexible structure such as a plastic bottle, while also being printable, specifically when inks that are otherwise difficult to retain on a film surface are employed. The additive selected to enhance the printability of the microvoided film may be any of the ones described in the referenced patents that are compatible with the structural material used to form the film.

The microvoided film of the present invention may be suitable in a wide array of applications as a monolayer film. It may also form part of a multilayer film wherein the composition of the primary structural material, the microvoid forming additive, the printability additive and any other optional selected additives form a layer that is co-extruded with one or more layers of other compositions and processed as described herein or otherwise processed to produce a film product with desirable properties. The other layers also include the microvoid forming additive, although the quantity of microvoiding may be selectable from layer to layer. In a first embodiment of a multilayer arrangement of the film of the present invention, the film is a two-layer film wherein both layers include the microvoid forming additive and the printability additive. In a second embodiment of a multilayer arrangement of the film of the present invention, the film is a two-layer film wherein both layers include the microvoid forming additive and only one layer includes the printability additive. In a third embodiment of a multilayer arrangement of the film of the present invention, the film is a three-layer film wherein all three layers include the microvoid forming additive and only the two outer layers include the printability additive. In a fourth embodiment of a multilayer arrangement of the film of the present invention, the film is a three-layer film wherein all three layers include the microvoid forming additive and only one of the two outer layers includes the printability additive. It can be seen that other combinations of greater numbers of layers of a multilayer film with reduced density and printability may be created with the present invention. Coloring pigment may be added to the composition of any one or more of the layers. For example, in a three-layer embodiment of the microvoided film, the second or middle layer may include a pigmenting additive, such as a black pigment to provide 100% opacity while still maintaining a white film surface.

While the example microvoided films represented in FIGS. 3-5 and otherwise described herein are representative of the invention, they are in no way are intended to be limiting of the principal concept of the invention. All equivalents are deemed to fall within the scope of this description of the invention as described by the following claims.

What is claimed is:

1. A film comprising:
a. a composition including a polymeric material and a printability additive including ethyl-vinyl-acetate or ethyl-methacrylate selected to bloom to a surface of the film during film formation processing; and
b. a microvoid forming additive mixed with the composition, wherein the microvoid forming additive is selected to generate microvoids in the polymeric material when forming the film sufficient to reduce the density of the polymeric material.

2. The film of claim 1 wherein the microvoid forming additive is selected to generate β crystallization of the polymeric material.

3. The film of claim 2 wherein the polymeric material is polypropylene.

4. The film of claim 1 wherein the microvoid forming additive is mixed with the composition in sufficient quantity to render the film opaque.

5. The film of claim 1 wherein the composition includes a pigment additive.

6. The film of claim 5 wherein the pigment additive is a whitening additive.

7. The film of claim 1 wherein the density of the polymeric material is about 1.12 g/cc and the quantity of microvoid forming additive added to the composition is sufficient to reduce the density of the film to about 0.75 g/cc.

8. A film comprising:
a. a first layer; and
b. a second layer, wherein the first layer and the second layer include a composition including a polymeric material and a microvoid forming additive selected to generate microvoids in the polymeric material sufficient to reduce the density of the polymeric material, and wherein at least one of the first layer and the second layer includes a printability additive including ethyl-vinyl-acetate or ethyl-methacrylate selected to bloom to a surface of the film during film formation processing.

9. The film of claim 8 further comprising a third layer, wherein the third layer includes the polymeric material and the microvoid forming additive.

10. The film of claim 9 wherein the first layer and the third layer are sandwiched around the second layer, and wherein at least one of the first layer and the third layer includes the printability additive.

11. The film of claim 10 wherein the second layer includes a pigment additive.

12. The film of claim 11 wherein the pigment additive is a black additive.

13. The film of claim 8 wherein the polymeric material is polypropylene.
